(19) United States
(12) Patent Application Publication
(10) Pub. No.: US 2015/0030446 A1
(43) Pub. Date: Jan. 29, 2015

(54) NACELLE FOR AN AIRCRAFT BYPASS TURBOJET ENGINE

(71) Applicant: Aircelle, Gonfreville L'Orcher (FR)

(72) Inventors: Patrick Gonidec, Bretx (FR); Laurent Albert Blin, Sainte Adresse (FR)

(73) Assignee: Aircelle, Gonfreville L'Orcher (FR)

(21) Appl. No.: 13/946,316

(22) Filed: Jul. 19, 2013

Related U.S. Application Data
(63) Continuation of application No. PCT/FR2012/050051, filed on Jan. 9, 2012.

(30) Foreign Application Priority Data
Jan. 19, 2011 (FR) 11/50412

(51) Int. Cl. B64D 29/06; B64D 33/02

(52) U.S. Cl. CPC B64D 29/06; B64D 33/02; B64D 2033/0266; B64D 2033/0273
USPC 415/220; 137/15.1

(57) ABSTRACT

The disclosure relates to a nacelle for a turbojet engine, including an upstream section forming an air intake lip and defining a space for the circulation of a main air flow. The nacelle includes a device for modulating the cross-section of the space and has means for injecting an auxiliary flow of a gas by means of an induced ejector effect; suction means for drawing in the injected auxiliary flow; and an internal auxiliary flow return area in one or more walls, the area being configured to allow the circulation of the injected auxiliary flow and the drawn-in auxiliary flow and to bring part of the injected auxiliary flow into contact with the main air flow. The internal return area includes an outer front part forming an area in which the thickness of the internal return area is reduced.

### CROSS-REFERENCE TO RELATED APPLICATIONS

This application is a continuation of International Application No. PCT/FR2012/050051, filed on Jan. 9, 2012, which claims the benefit of FR 11/50412, filed on Jan. 19, 2011. The disclosures of the above applications are incorporated herein by reference.

### FIELD

The present disclosure relates to a nacelle for an aircraft bypass turbojet engine as well as to an aircraft including one such nacelle.

### BACKGROUND

The statements in this section merely provide background information related to the present disclosure and may not constitute prior art.

An aircraft is driven by several turbojet engines each accommodated in a nacelle also harboring a set of auxiliary actuation devices related to its operation and ensuring various functions when the turbojet engine is operating or at a standstill. These auxiliary actuation devices notably comprise a mechanical system for actuating a thrust reverser.

A nacelle generally has a tubular structure along a longitudinal axis, comprising an air intake upstream from the turbojet engine, a middle section intended to surround a fan of the turbojet engine, a downstream section harboring thrust reversal means and intended to surround the combustion chamber of the turbojet engine. The tubular structure generally ends with an ejection nozzle, the outlet of which is located downstream from the turbojet engine.

Modern nacelles are intended to harbor a dual flux turbojet engine capable of generating via rotating blades of the fan a hot air flow (also called a “primary flow”) stemming from the combustion chamber of a turbojet engine, and a cold air flow (“secondary flow”) which circulates outside the turbojet engine through a ring-shaped passage also called an “annular vein”.

By the term of “downstream” is meant here the direction corresponding to the direction of the cold air flow penetrating the turbojet engine. The term of “upstream” designates the opposite direction.

Said annular vein is formed by an external structure called an outer fixed structure (OFS) and an internal concentric structure called an inner fixed structure (IFS) surrounding the structure of the engine strictly speaking downstream from the fan. The internal and external structures belong to the downstream section. The external structure may include one or several cowls sliding along the longitudinal axis of the nacelle between a position allowing escape of the reversed air flow and a position preventing such an escape.

Moreover, in addition to its thrust reversal function, the sliding cowl belongs to the rear section and has a downstream side forming the ejection nozzle aiming at channeling the ejection of the cold air flow, designated hereafter by “main air flow.” This nozzle provides the power required for propulsion by imparting speed to the ejection flows. This nozzle is associated with an actuation system either independent of that of the cover cowl or not, giving the possibility of varying and optimizing its section depending on the flight phase in which the aircraft is found.

It may prove to be advantageous to reduce the inlet or ejection section of the main air flow in the space formed by the air intake and the annular vein.

Reducing the section for ejecting the main air flow at the outlet of the annular vein via a variable nozzle formed by the sliding cowls of the OFS is presently known. Such a variable nozzle gives the possibility of modulating the thrust by varying its outlet section in response to variations in the adjustment of the power of the turbojet engine and to flight conditions.

However, the variation of the ejection section for the main air flow is not always sufficiently fast because of the inertia of the mechanical parts forming the variable nozzle, in the case of a very fast modification of the flight conditions.

Devices are known which allow very fast modulation of the ejection section for the main air flow. Nevertheless, this type of devices increases the weight of the nacelle and comprises complex mechanisms which are often a penalty for the overall reliability and the propulsion performances by significant aerodynamic losses. It is sought to avoid this type of defect in civil aircraft where the savings in mass, the increase in reliability and in propulsion performances as well as the decrease in aerodynamic losses are promoted.

No fast and reliable device is known, allowing modification of the ejection section of the main air flow in the annular vein while retaining the mass of a nacelle and providing very little aerodynamic loss.

A known solution for modifying the section and applied to the air intake sections consists of injecting an auxiliary gas flow.

More specifically, these devices are applied for nacelles of turbojet engines having a longitudinal axis and including walls delimiting a space in which a main airflow circulates.

The devices for modulating the cross-section of said space include:
means for injecting an auxiliary flow of gas, configured in order to vary the orientation and/or the speed of said auxiliary flow;
means for drawing in at least one portion of this injected auxiliary flow; and
an internal area for returning the auxiliary flow into one or several walls, said area being configured so as to allow circulation of the portion of the injected auxiliary flow and of the drawn-in auxiliary flow, and for putting into contact a portion of the injected auxiliary flow and of the main airflow.

By “main airflow which circulates” is meant the penetration of the main airflow into the space, the circulation of said airflow in this space and the ejection or the outflow of this airflow out of this space.

By “cross-section,” is meant a transversely made section relatively to the longitudinal axis of the nacelle.

The modulation device of the nacelle of the present disclosure generates in a one-off and reliable way, a distortion of the limiting layer formed by the contact between the gas of the auxiliary flow and the air of the main flow. The thickness of this distortion of the limiting layer generates a reduction in the inlet or outlet section felt by the main flow.

The thickness of this limiting layer is of greater or lesser extent depending on the injection means and on the suction means.

Consequently, the device for modulating the nacelle of the present disclosure gives the possibility in a simple, effective, reliable and very fast way of modifying the size of the section of the main airflow. The response time of the device is not limited by the inertia of the chemical parts of large dimensions which have to move between each other. Mention may be made as an example of a mechanical part of large dimensions, of the thrust reversal sliding cowl panels or of the air intake internal panel. Such devices are notably described in documents GB 1,298,069 and U.S. Pat. No. 6,655,632 notably. However there exists a general need for improvement and enhancement of these devices.

### SUMMARY

For this purpose, the present disclosure provides for a nacelle for an aircraft bypass turbojet engine having a longitudinal axis and upstream section comprising an air intake structure equipped with an air intake lip, an internal wall of which defines a circulation space for a main airflow, said nacelle comprising at least one device for modulating the cross-section of said space, positioned in the wall of the air intake lip and including:

means for injecting an auxiliary flow of a gas, configured so as to vary the orientation and/or the speed of said auxiliary flow by an induced ejector effect;

means for drawing in at least one portion of this injected auxiliary flow; and

an internal area for return of the auxiliary flow in one or several walls, said area being configured so as to form a cavity allowing circulation of the portion of the injected auxiliary flow and of the drawn-in auxiliary flow and the contacting of one portion of the injected gas auxiliary flow and of the main airflow, comprising, in order to do this, at least one downstream aperture configured for drawing in at least one portion of the gas in contact with the air of the main flow and an upstream outlet configured for allowing circulation of the gas injected by the injection means and the gas circulating in the cavity, characterized in that the internal return area has an external front portion forming a striction area of the internal return area.

It should be noted that the induced injector effect gives the possibility of not using any pump or any other mechanical system.

According to other features of the present disclosure, the nacelle includes one or several of the following optional features considered alone or according to all possible combinations:

the gas of the auxiliary flow is air which gives the possibility of avoiding the weighing down of the nacelle by the transport of a particular gas;

the injection means comprise an ejection nozzle which gives the possibility of simply ejecting with little room, the gas of the auxiliary flow;

the ejection nozzle is orientable which gives the possibility of modifying the thickness of the limiting layer formed by the contact between the auxiliary flow and the main flow notably by adapting the confluence angle formed between the flow of the injected gas and the main flow;

the injection means comprise a gas bleeding system comprising at least one valve configured for varying the flow rate of the auxiliary flow;

the valve(s) is(are) controlled by sensors which allow modification of the auxiliary flow according to the changes in flight conditions;

the suction means are selected from a monolithic perforated wall, a wall with honeycomb cells, grids, notably vane grids, trellises, one or several slots either longitudinal or not, which allow effective and not very cumbersome suction;

the injection and/or suction means are controlled by a device modifying the kinetic energy, the flow rate and the orientation of the auxiliary flow which allows control of the thickness of the circulation area substantially distorting the limiting layer;

the internal return area is a cavity comprising a downstream aperture configured for drawing in at least one portion of the gas in contact with the air of the main flow and an upstream outlet configured for allowing the circulation of the gas injected by the injection means and the gas circulating in the cavity, which simplifies the installation;

the wall substantially facing the auxiliary flow injected by the injection means has a rounded or angled surface with which it is possible to have a desired profile of the auxiliary flow and a desired shape of the circulation area.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a partial schematic sectional view of one form of a nacelle of the present disclosure;

FIGS. 2 to 4 are partial schematic lateral sectional views of the form of a modulation device of the nacelle of FIG. 1 in which the thickness of the limiting layer is more or less substantial;

FIGS. 5a and 5b are partial schematic lateral sectional views of the air intake lip of the form of the nacelle of FIG. 1 including the modulation device according to FIG. 4 and FIG. 3 respectively;

FIG. 5c is a partial schematic lateral sectional view of the air intake lip in an alternative of FIGS. 5a and 5b;

FIGS. 6a and 6b are partial schematic lateral sectional views of the downstream section of the form of the nacelle of FIG. 1 including the modulation device according to FIG. 4 and FIG. 3 respectively mounted on the external structure;

FIGS. 7a and 7b are partial schematic lateral sectional views of the downstream section of the form of the nacelle of FIG. 1 including the modulation device according to FIG. 4 and FIG. 3 respectively mounted on the fixed internal structure;

FIGS. 8a, 8c and 8e are partial schematic lateral sectional views of the air intake lip of different forms of the air intake lip of FIGS. 5a to 5c;

FIGS. 8b, 8d and 8f are partial cross-sectional views of the air intake lip of the respective forms of FIGS. 8a, 8c and 8e;

FIG. 9 is a partial schematic lateral sectional view of an alternative of the form of FIG. 2;

FIG. 10a is a partial schematic lateral sectional view of the air intake lip of an alternative of FIG. 5c;

FIG. 10b is a partial schematic lateral sectional view of the downstream section of an alternative of FIG. 6a.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

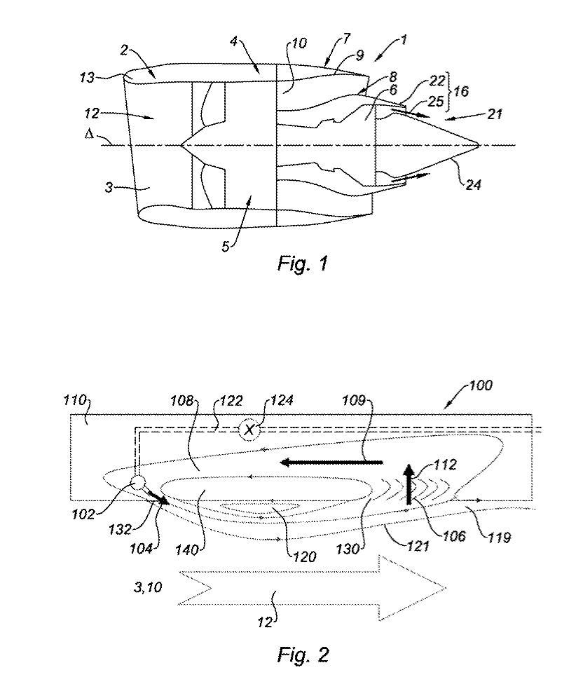

As illustrated in FIG. 1, a nacelle 1 according to the present disclosure has a substantially tubular shape along a longitudinal axis Δ. The nacelle 1 comprises an upstream section 2 with an air intake lip 13 forming an air intake 3, a middle section 4 surrounding a fan 5 of a turbojet engine 6 and a downstream section 7. The downstream section 7 comprises a fixed internal structure 8 (IFS) surrounding the upstream portion of the turbojet engine 6, a fixed external structure (OFS) 9 and a moveable cowl (not shown) including thrust reversal means.

The IFS 8 and the OFS 9 delimit an annular vein 10 allowing the passage of a main airflow 12 penetrating the nacelle 1 of the present disclosure at the air intake 3.

The nacelle of the present disclosure 1 therefore includes walls delimiting a space, such as the air intake 3 or the annular vein 10, into which the main airflow 12 penetrates, circulates and is ejected.

The nacelle 1 of the present disclosure ends with an ejection nozzle 21 comprising an external module 22 and an internal module 24. The internal 24 and external 22 modules define a flow channel for a hot air flow 25 leaving the turbojet engine 6.

As illustrated in FIG. 2, the nacelle of the present disclosure 1 comprises at least one device 100 for modulating the section of said space 3, 10 including:
means 102 for injecting an auxiliary flow of a gas 104 configured for varying the orientation and/or the speed of said auxiliary flow 104;
means 106 for drawing in at least one portion of this injected auxiliary flow 104; and
an internal return area 108 for the auxiliary flow 109 in one or several walls 110, said area 108 being configured so as to allow circulation of the portion of the injected gas flow 104 and of the drawn-in gas flow 112, and for putting into contact a portion of the injected auxiliary flow 104 and of the main airflow 12.

The modulation device 100 in a one-off and reversible way generates an area 120 for circulation of the limiting layer formed by the contact between the gas of the auxiliary flow 104 and the air of the main flow 12. A lost portion 119 of the secondary airflow comprised between the maximum flow line 121 of the auxiliary flow in the space and the limiting layer is driven with the main airflow 12. This lost portion 119 may be of greater or lesser extent depending on the thickness of the limiting layer. The more the circulation area 120 has a substantial height, the more the injection flow rate is significant. Indeed, the flow rate loss is significant in this configuration.

The lost portion 119 is driven by the main flow 12 without perturbing the operation of the nacelle 1 of the present disclosure.

The use of injection 102 and suction 106 means associated with an internal return area 108 allows reduction of the flow injected into the main flow 12 since a portion of the flow is taken up by suction and circulates in the internal return area 108. Therefore, the perturbation in the operation of the nacelle 1 due to the injection of an auxiliary flow by the modulation device 100 of the present disclosure is reduced relatively to the perturbation generated by a continuous injection of a gas flow without any suction of the latter.

The device of the present disclosure further allows circumvention of the portion of the turbulent auxiliary flow which does not substantially affect the performance of the nacelle 1 of the present disclosure.

The thickness of the circulation area 120 of the limiting layer generates a reduction in the inlet or outlet section felt by the main flow 12. The thickness of said circulation area 120 is of lesser or greater extent depending on the injection means 102 and on the suction means 106.

Therefore, the modulation device 100 in a simple, efficient, reliable and very fast way, allows modification of the size of the section of the space 3, 10. The response time of the device 100 is not limited by the inertia of the mechanical parts which have to move between each other.

Further, the presence of means for injection and suction of a gas flow gives the possibility of avoiding a too powerful flow with a too significant flow rate. Such a flow would be difficult to control. Thus, a permanent flow rate of the auxiliary flow 104 and 112 occurs at the limiting layer in contact with the main airflow 12. Such a flow rate generates thrust forces improving the operation of the turbojet engine, notably in the case of overheating of the latter.

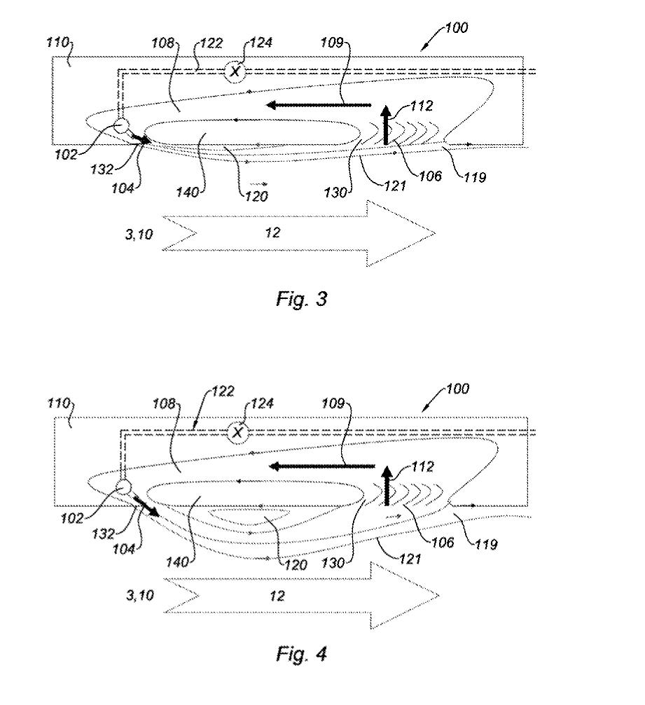

FIGS. 2 to 4 show the variation of the thickness of the circulation area 120 of the limiting layer according to the orientation of the auxiliary flow and/or to the speed of the latter. Thus, the thickness is all the larger since the speed of the injected gas 104 is high or the orientation of the flow of the gas has a certain angle. Thus, as an example, if said angle is comprised from 0° and 90°, 0° substantially corresponding to aligned ejection and opposed to the main flow 12, the injected auxiliary flow 104 opposes the main flow 12. This induces a front detachment of the limiting layer and a circulation area 120 of a large size which depends on the speed of the injected gas. According to another example, if said angle is comprised between 90° and 180°, 180° corresponding to an ejection of the auxiliary flow, substantially tangential to the wall in the direction of the flow of the main flow 12, the auxiliary flow 104 is added with the main flow. This has the effect of reducing the size of the circulation area 120. The limiting layer then behaves as a treadmill towards the wall 110 in contact with the limiting layer.

The gas of the auxiliary flow 104, 112, 109 is preferentially air which gives the possibility of avoiding the weighing down of the nacelle 1 of the present disclosure by the transport of a thicker gas. Thus, the injected air 104 may be recovered downstream from the nacelle 1 of the present disclosure, for example in an area containing the turbojet engine 6 or in proximity to the latter. To do this, the air injected as an auxiliary flow may be captured on the hot primary flow of the turbojet engine so as to reduce the captured flow rate and have significant energy. This air may advantageously be used for defrosting the wall 110 of the section.

The injection means 102 are configured in order to vary the speed and/or the orientation of the secondary flow 104 by an ejector effect induced by the auxiliary flow 104. The injection means 102 may comprise an ejection nozzle which allows simple injection and in little room, of the gas of the auxiliary flow 104.

The ejection nozzle may be orientable which allows modification of the thickness of the limiting layer 120. To do this, it is possible to adapt the confluence angle between the flow of the injected gas and the main flow. To do this, the ejection nozzle may be connected to sensors connected to the turbojet engine 6 allowing modification of the orientation of said nozzle if need be.

The injection means 102 may also comprise a system 122 for taking up gas forming the auxiliary flow 104, comprising at least one valve 124 configured for varying the flow rate of the secondary air flow 104. The bleeding system 122 typically comprises pipes as illustrated in FIGS. 2 to 4 for bringing said gas to the injection means 102. As indicated above, when the gas is air, the pipes may open onto an area in proximity to the turbojet engine 6.

The valve(s) 124 may be controlled by sensors, notably sensors connected to the turbojet engine 6, in particular to the FADEC. Consequently, the injection of the gas into the space 3, 10 is achieved so as to improve the operation of the turbojet engine 6 according to the flight conditions. The use of valves 124 allows control of the flow rate and of the kinetic energy of the injected auxiliary flow 104 which allows modulation of the distortion of the limiting layer in fine produced in the main flow 12 and therefore a change in the passage section by the single action on the valve(s) 124.

Moreover, the internal return area delimits with the circulation area, an islet profile of the limiting layer or further with a substantially bulged shape. This profile is advantageously maintained by means of plates positioned substantially radially and suitably aligned with the injected flow. The substantially longitudinal plates may be located in the injection area but also in the suction area wherein they reinforce the permeable grids or walls.

The suction by said suction means 106 mainly uses the negative pressure generated by the injection means 102 located upstream from the suction means 106 which tends to draw in the gas inside the cavity from the downstream area to the upstream area. This effect is notably known under the name of an ejection pump or ejector.

The suction means 106 may be selected from a monolithic perforated wall, a wall with honeycomb cells, grids, notably vane grids, trellises, one or several slots either longitudinal or not, which allows efficient and not very cumbersome suction.

In particular, the suction means may be in the form of suction orifices, notably of oriented vane grid(s). By using such oriented vane grid(s) it is possible to make the suction even more efficient and less cumbersome.

According to one form, the injection 102 and/or suction 106 means may be controlled by a device for modifying the kinetic energy, the flow rate and the orientation of the auxiliary flow 104 and 112 which allows control of the thickness of the circulation area 120 of the limiting layer. As an example, mention may be made of substantially orientable suction grids, of substantially orientable nozzles and of a variable size orifice by the use of a diaphragm for example.

The internal return area 108 may be a cavity, notably an annular cavity, comprising a downstream aperture 130, configured for drawing in at least one portion of the gas 112 of the auxiliary flow in contact with the air of the main flow 12 and an upstream outlet 132 configured for allowing circulation of the gas 104 injected by the injection means 102 and the gas 109 circulating in the cavity. Such a cavity simplifies the installation of the modulation device 100 and neither weighs down the nacelle 1 of the present disclosure.

According to one form, the wall 140 substantially facing the gas flow 104 injected by the injection means 102 has a rounded or angled surface which gives the possibility of having the desired profile of the auxiliary flow.

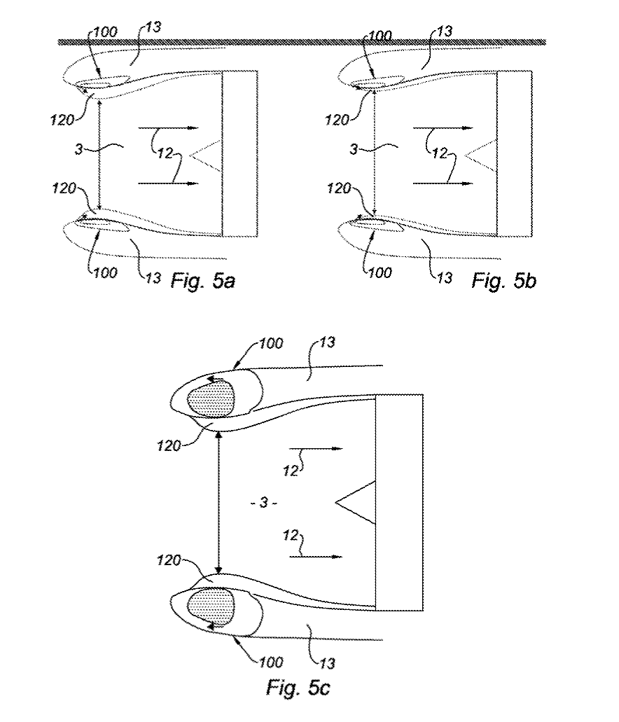

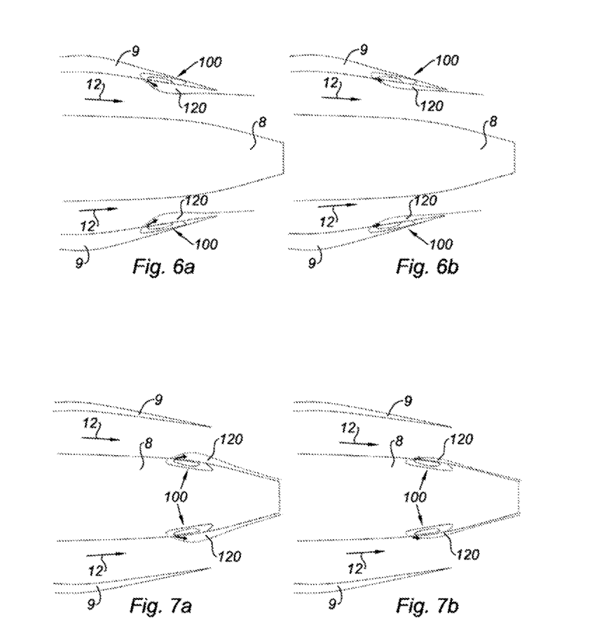

The modulation device 100 may be positioned in the wall of the air intake lip 13 (see FIGS. 5a, 5b and 5c), in the wall of the external structure 9 (see FIGS. 6a and 6b) and/or in the wall of the internal structure 8 (see FIGS. 7a and 7b).

In the case of a modulation device 100 positioned in the wall of the air intake lip 13, the internal return area may advantageously encompass said air intake lip 13, notably at the leading edge of the nacelle, and thereby ensure defrosting thereof when the injected gas is at a suitable temperature, notably when said gas is taken up at the primary flow of the turbojet engine. Mutualization of the functions for controlling the air intake and defrosting section thus allows significant savings in mass.

In a more specific way, the external front portion of the internal return area may be formed by the air intake lip. It is possible to modify the shape of the circulation area of the limiting layer in order to generate striction at the beginning of the wall to be defrosted and localize therein injection means (see FIG. 5c).

The hot gas used for defrosting may thus be substantially injected at the beginning of the area to be defrosted. At the wall of the air intake lip, the flow in contact with the wall is hotter and may be accelerated to the location for the defrosting. In this form, the front partition of the air intake may correspond to the upstream portion of the internal return area.

The gas flow drawn in by the suction means is less hot downstream from the injection. Consequently, the downstream partition is less hot than that of the nacelle using a defrosting device of the prior art. Defrosting is thus improved.

The circulation area of the limiting layer wherein the thickness is substantially the thickest may be used as a conduit for supplying and distributing the injected auxiliary flow. In order to decouple the defrosting system from the control of the outlet section, one or several injection means may be affixed to those of the defrosting and an additional outlet may be added on the external portion of the nacelle 1, notably at the junction between the air intake lip 13 and the external panel of the middle section 4. This allows discharge of a portion of the flow being used for defrosting if need be. Defrosting is typically carried out during take-off and descent phases where the section of the air intake lip 13 will have to be the smallest section.

Consequently, the space is then the annular vein 10 formed by the walls of the fixed internal structure 8 and the external structure 9 or the air intake 3 formed by the air intake 13.

The modulation device 100 generates thrust forces which may contribute to optimizing the operation of the turbojet engine 6, notably when said device 100 is installed in the downstream section 7 in the walls of the fixed internal structure 8 and of the external structure 9.

In the case when the modulation device 100 is installed in the walls of the air intake lip 13 and depending on the thickness of an area called a “dead water” area, it is possible to increase the speed of the main flow 12 so as to obtain a sonic neck capable of annihilating any noise annoyance due to the blades of the fan of the turbojet engine.

As this is visible in FIG. 5a, the modulation device 100 is in a configuration which accelerates the speed of the main airflow 12 and therefore blocks the noise annoyances passing through this sonic neck.

The modulation device 100 of the form of FIG. 5b allows optimization of the thrust according to the speed of the aircraft.

In both of these forms, by adapting the size of the section of the main airflow 12, it is possible to improve the operation of the turbojet engine 6 and the pressure to which the air intake 3 is subject.

In particular, during the take-off and descent phases of the aircraft, the modulation device 100 allows an increase in the section of the space 3 in order to follow the operating speed of the turbojet engine 6 and improve the latter.

The modulation device 100 may also be used for transferring energy to the limiting layer in the case of a cross-wind relatively to the nacelle 1 of the present disclosure, by positioning the limiting layer sufficiently upstream on the air intake lip 13 and by using a suitable injection angle. With this configuration, it is possible to withstand a cross-wind with a finer aerodynamic profile and a more lightweight structure than in the prior art.

Said device 100 may be used as a particularly efficient integrated defrosting system by extending the internal return area 108 to the whole of the air intake lip 13 to be defrosted.

The modulation device 100 of the forms of FIGS. 6a and 7a allows strong injection while reducing the ejection section for the main airflow 12. This configuration generally corresponds to a so-called cruising mode.

The modulation device 100 of the forms of FIGS. 6b and 7b on the other hand allows low injection corresponding to an intensive operating phase of the turbojet engine 6 coupled with acoustic attenuation, notably during the take-off phase.

In these four forms, the flow rate of the gas auxiliary flow is improved according to the operating speed of the turbojet engine and according to the selected configuration. Thus, a reduction in the ejection section of the space 10 generates acoustic attenuation and allows a very strong expansion rate of the turbojet engine 6 at low speed by optimizing the cycle of the latter at a large dilution rate. Thus, the modulation device 100 advantageously allows replacement of the variable nozzles used in the downstream section of the nacelle 1.

According to a form not shown, the nacelle may include a modulation device or else a plurality of modulation devices. In the case of a plurality of devices, the latter may be positioned in a same location or in different locations of the nacelle, for example at the air intake lip and at the external structure. In this case, the injected auxiliary flow may be injected in a different way both as regards the ejection angle and the flow rate used.

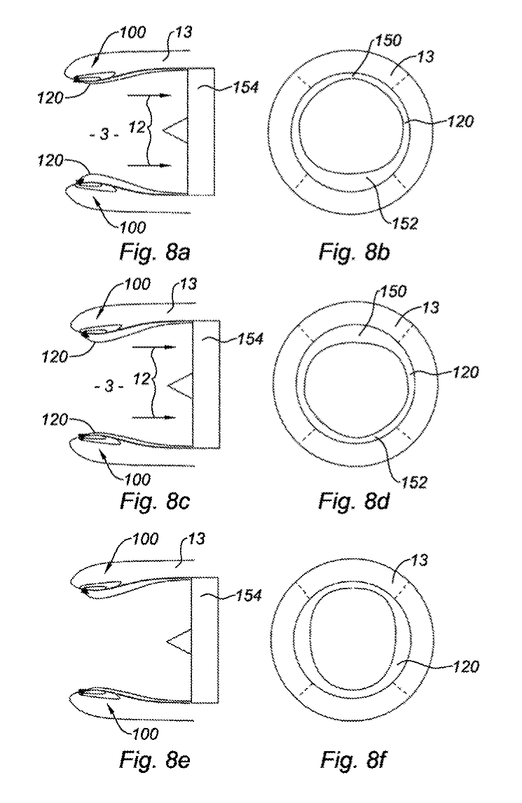

In the case of an air intake 3, the low portion 152, or further called a 6 o'clock portion, when the air intake 3 is seen from the front, may have a thick circulation area 120 relatively to the upper portion 150, or further called a 12 o'clock portion, when the air intake 3 is seen from the front, in order to avoid distortion of the flow on the low portion 152 of the fan 154 during the take-off of the aircraft (see FIGS. 8a and 8b).

In the case of an air intake 3, the upper portion 150 may have a thick circulation area relatively to the low portion 152 in order to avoid divergence of the flow (see FIGS. 8c and 8d), during the cruising mode of the aircraft.

In the case of an air intake 3, the side portion of the nacelle or both of them, when the air intake 3 is seen from the front, may have a thicker circulation area 10 than the circulation area 120 of the upper portion 150 and of the low portion 152 in order to avoid distortion of the flow on the fan 154 (see FIGS. 8e and 8f) upon take-off with a cross-wind.

Thus, it is possible to modify the section of the air intake lip without making the design of the air intake lip 3 more complex. Further, it is possible to have savings in mass by reducing the leading edge thickness and the length of the air intake lip 13.

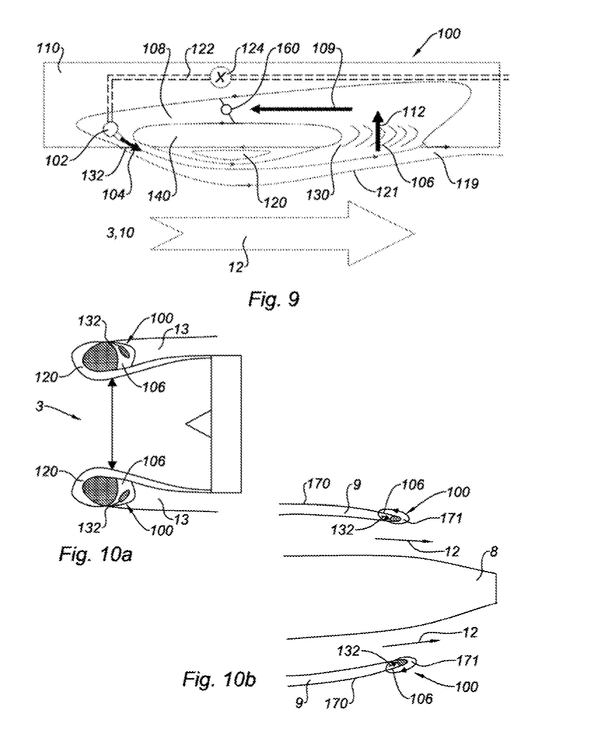

As illustrated in FIG. 9, in the case of the control of an air intake 3 or of an injection nozzle 21, a device for modifying the section of the internal return area 108 may be installed in order to improve the structure of the flow of the auxiliary flow 109 and the size of the recirculation area 120. As an example, said device may include a valve 160 positioned in the internal return area 108 and/or a moveable wall subject to one of the walls 110, 140 delimiting the internal return area 108.

In the case of control of the aerodynamic circulation around the nacelle, the present disclosure may be used jointly in the air intake and in the ejection outlet. In this case, it may be of interest, on the air intake, to localize the ejection area 132 or the suction area 106, one on the outside of the air intake 3 and the other inside, according to the intended purpose (see FIG. 10a). Also, for the ejection nozzle, the suction area 106 may be localized on the external wall 170 of the nacelle, generating circumvention 171 of the trailing edge of the nacelle (see FIG. 10b).

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A nacelle for an aircraft dual flux turbojet engine having a longitudinal axis and an upstream section comprising an air intake structure equipped with an air intake lip, an internal wall of which defines a space for circulation of a main airflow, said nacelle comprising at least one device for modulating the cross-section of said space positioned in the wall of the air intake lip and including:
means for injecting an auxiliary flow of a gas, configured for varying the orientation and/or the speed of said auxiliary flow by an induced ejector effect;
means for drawing in at least one portion of this injected auxiliary flow; and
an internal area for return of the auxiliary flow in one or several walls, said area being configured so as to form a cavity allowing the circulation of the portion of the injected auxiliary flow and of the drawn-in auxiliary flow and the contacting of a portion of the injected gas auxiliary flow and of the main airflow, comprising, in order to do this, at least one downstream aperture, configured for drawing in at least one portion of the gas in contact with the air of the main flow and an upstream outlet configured for allowing the circulation of the injected by the injection means and the gas circulating in the cavity,
characterized in that the internal return area has an external front portion forming a striction area of the internal return area.

2. The nacelle according to claim 1, wherein the gas of the auxiliary flow is air.

3. The nacelle according to claim 1, wherein the injection means comprise an ejection nozzle.

4. The nacelle according to claim 3, wherein the ejection nozzle is orientable.

5. The nacelle according to claim 1, wherein the injection means comprise a gas bleeding system comprising at least one valve configured for varying the flow rate of the auxiliary flow.

6. The nacelle according to claim 5, wherein the at least one valve is controlled by sensors.

7. The nacelle according to claim 1, wherein the suction means are selected from a monolithic perforated wall, a wall with honeycomb cells, grids, notably vane grids, trellises, one or several slots either longitudinal or not.

8. The nacelle according to claim 1, wherein the injection and/or suction means are controlled by a device for modifying the kinetic energy, the flow rate and the orientation of the auxiliary flow.

9. The nacelle according to claim 1, wherein the wall facing the gas auxiliary flow injected by the injection means has a rounded or angled surface.
